(19) United States
(12) Patent Application Publication
(10) Pub. No.: US 2015/0242884 A1
(43) Pub. Date: Aug. 27, 2015

(54) CROSS-VERTICAL PUBLISHER AND ADVERTISER REPORTING

(71) Applicants: David K. Goodman, Brooklyn, NY (US); Emre Y. Baran, New York, NY (US); Michael Denisenko, New York, NY (US); David Perron, Ronkonkoma, NY (US); Edward Francis Higgins, III, San Francisco, CA (US)

(72) Inventors: David K. Goodman, Brooklyn, NY (US); Emre Y. Baran, New York, NY (US); Michael Denisenko, New York, NY (US); David Perron, Ronkonkoma, NY (US); Edward Francis Higgins, III, San Francisco, CA (US)

(21) Appl. No.: 13/324,647

(22) Filed: Dec. 13, 2011

Related U.S. Application Data
(60) Provisional application No. 61/422,570, filed on Dec. 13, 2010.

(51) Int. Cl. G06Q 30/02

(52) U.S. Cl. CPC G06Q 30/0246

(57) ABSTRACT

Methods, systems, and apparatus, for reporting publisher and advertiser advertising metrics across verticals. In one aspect, a method includes accessing impression data describing impressions of advertisements on publisher resources, wherein for each impression of an advertisement on a publisher resource, the impression data identifies a publisher and categories to which the publisher belongs, an advertiser and verticals to which the advertiser belongs, and attributes of the impression; receiving benchmark specification data defining a benchmark specification for one of the publishers or the advertisers, and further defining performance metrics based on the attributes of the impressions for the publisher or the advertiser and impressions of other publishers and other advertisers; and generating reporting data for displaying a benchmark report of performance metrics for one of the publishers or advertisers respectively relative to other publishers or advertisers and grouped by a respective publisher category or advertiser vertical.

### CROSS-REFERENCE TO RELATED APPLICATION

This application claims priority under 35 U.S.C. §119(e) to U.S. Provisional Application Ser. No. 61/422,570 titled “Cross-Vertical Publisher and Advertiser Reporting” filed Dec. 13, 2010, the disclosure of which is incorporated herein by reference in its entirety.

### BACKGROUND

This specification relates to Internet advertising.

The Internet provides access to a wide variety of resources, such as video and/or audio files, as well as web pages for particular subjects or particular news articles. Access to these resources has provided opportunities for advertisements to be provided with the resources. For example, web pages can include advertisement slots in which advertisements can be presented. The advertisements slots can be defined in the web page or defined for presentation with a web page. In some cases, advertisement slots may be provided in different categories of publishes (e.g., entertainment related websites, news related websites, political related websites, etc.).

There are many different campaign strategies that an advertiser can pursue. Some of the advertisement campaign strategies may be highly effective, while others may not. In some cases, it may be difficult for an advertiser to exploit opportunities that may exist across verticals and different publisher categories.

### SUMMARY

This specification describes technologies relating reporting for publishers and advertisers for on-line advertisements.

In general, one innovative aspect of the subject matter described in this′specification can be embodied in methods that include the actions of accessing impression data describing impressions of advertisements on publisher resources, wherein for each impression of an advertisement on a publisher resource, the impression data comprises: a publisher identifier that identifies a publisher on which the advertisement was impressed and publisher category identifiers identifying categories to which the publisher belongs, an advertiser identifier that identifies an advertiser of the advertisement and advertiser vertical identifiers identifying industry verticals to which the advertiser belongs, and attribute data describing the attributes of the impression, the attribute data comprising pricing data describing cost-related attributes of the impression, and interaction data describing user interaction events of the impression; receiving benchmark specification data defining a benchmark specification for one of the publishers or the advertisers, and further defining performance metrics based on the attributes of the impressions for the publisher or the advertiser and impressions of other publishers and other advertisers; and generating reporting data for displaying a benchmark report, the reporting data defining a report of performance metrics for one of the publishers or other advertisers respectively relative to other publishers or advertisers and grouped by at least one respective publisher category or advertiser category. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. The cross vertical publisher and advertiser report data can allow for analysis of display advertising metrics and for the derivation of benchmarks from the metrics based on the advertiser vertical of the advertiser and the publisher category of webpages on which the advertisements are displayed. The reports can also facilitate analysis of the following aspects: auction pressure for each category that the advertisement is appearing on and advertiser performance on each publisher category by advertiser vertical. The reports can also facilitate the provisioning of benchmark guidance to advertisers before the advertisers launch their campaigns, and for the provisioning of feedback as to how advertisers' campaigns are performing compared to their peers and across all advertisers in general. The reports can also facilitate scaled analysis of the different publisher and advertiser regions and countries to compare supply and demand levels across the advertising network. The report data can also be joined with other data in an advertising network, due to the presence of publisher and advertiser identifiers. Such joining can facilitate advertiser/publisher segmentation within the advertisement network based on patterns of spend or targeting (e.g., defining run-of-network buyers vs. category-exclusive buyers).

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example advertising environment in a computer network.

FIGS. 2A-2C are block diagrams example report types based on different benchmark specifications.

FIG. 3 is a flow diagram of an example process for generating report data for a benchmark report.

FIG. 4 is an illustration of an example competitor category report.

FIG. 5 is an illustration of an example performance differential report.

FIG. 6 is an illustration of an example of vertical performance report.

FIG. 7 is an illustration of an example impression category report.

FIG. 8 is an illustration of an example advertiser benchmark report.

FIG. 9 is an illustration of an example competitor format report.

FIG. 10 is an illustration of an example competitor targeting type report.

FIG. 11 is an illustration of an example publisher category report.

FIG. 12 is an illustration of an example targeting type benchmark report.

FIG. 13 is an illustration of an advertisement format benchmark report.

Like reference numbers and designations in the various drawings indicate like elements.

### DETAILED DESCRIPTION

Overview

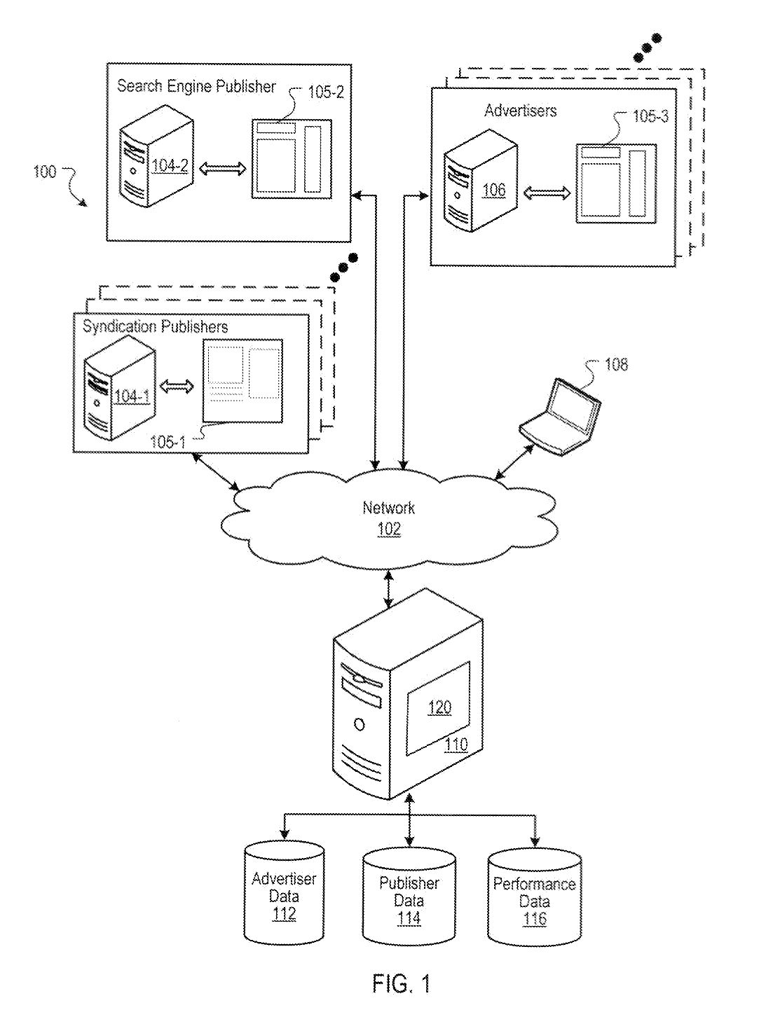

FIG. 1 is a block diagram of an example advertising environment in a computer network. A computer network 102, such the Internet, or a combination of the Internet and one or more wired and wireless networks, may connect syndication publishers 104-1, a search engine publisher 104-2, advertisers 106, a user device 108, and an advertisement management system 110. Only one representative entity is respectively shown for the syndication publisher 104-1 and the advertiser 106. However, the online environment 100 may connect many thousands of publishers and advertisers, as indicated by the phantom figures behind the syndication publisher 104-1 and the advertiser 106.

The user device 108 is an electronic device that may be under control of a user and may be capable of requesting and receiving resources 105 over the network 102. Example user devices 108 include personal computers, mobile communication devices and other devices that can send and receive data over the network 102. A user device 108 may typically include a user application, such as a web browser or other communication software, to facilitate the sending and receiving of data over the network 102.

The publishers 104 and, optionally, the advertisers 106 may maintain websites. Each website is one or more resource 105 associated with a domain name, and each can be hosted by one or more servers. A resource is any data that can be provided by the web site over the network 102 and that is associated with a resource address. Resources may include HTML pages, RSS feeds, and videos, for example. To avoid congestion in the drawings, the resources 105 are represented as web pages; however, the representations of FIG. 1 are inclusive of all types of resources that are consistent with the above definition.

As will be described in more detail below, each of the publishers may be in data communication with the advertisement management system 110 and together the publishers 104 and the advertisement management system 110 may facilitate the provisioning of advertisements with the publisher resources 105. In particular, the advertisement management system 110 may allow advertisers to define targeting rules that take into account attributes of the particular user to provide targeted advertisements for the users. Likewise, publishers 104 may also have targeting and restriction requirements for serving advertisements.

These targeted advertisements can be provided in many different properties, such as the properties of the syndication publisher 104-1 and the search engine publisher 104-2. The syndication publisher 104-1 can be a general content web site, e.g., a sports related web site, a news related web site, a social network web site, etc. When a user device 108 receives a resource 105-1 from the syndication publisher 104-1, the user device can render the webpage 105-1. The webpage 105-1 can include instructions that cause the user device to request advertisements from the advertisement management system 110. The advertisement management system 110, in turn, can provide targeted advertisements to the particular user. When a user selects an advertisement, the user device 108 can generate a request for a landing page of the advertisement, which is typically a webpage 105-3 of the advertiser 106.

The search engine publisher 104-2 can be a search service that provides advertisements to users with search results that are responsive to user queries. Typically, the search results can be provided in one part of the page, such as the left-hand side, and the advertisements can be provided in another part of the page, such as the right-hand side of the page. When the search engine publisher 104-2 provides the search results webpage 105-2 to the user device 108, the user device can render the webpage 105-2. The webpage 105-2 can include instructions that cause the user device to request advertisements from the advertisement management system 110. The advertisement management system 110, in turn, can provide targeted advertisements to the particular user.

The advertisement management system 110 can include a data storage system that stores advertiser data 112, publisher data, and performance data 116. The advertiser data 112 stores, for each advertiser 106, campaign data that can include advertisements, targeting information, and budgeting information for advertiser 106. The advertiser data 112 also can store vertical information that defines, for each advertiser 106, industry verticals that the advertiser belongs to. For example, if an advertiser is a computer manufacturer and sells personal computers, the advertiser may be determined to belong to the categories of electronics, computers, and consumer goods. The associations of advertisers with verticals may be provided by the advertisers themselves, may be determined by the advertisement management system 110, or may be provided by a third party.

The publisher data 114 can store, for each publisher 104, publisher identifiers, and for each resource the publisher 104 serves, categories that the resource are determined to belong to. For example, if the publisher is a website for classical music, the publisher resources may be determined to belong to the categories of entertainment and classical music. The associations of publishers with categories may be provided by the publishers themselves, may be determined by the advertisement management system 110, or may be provided by a third party.

The performance data 116 can store data indicating the performance of the advertisements that are served. Such performance data can include, for example, click through rates for advertisements, the number of impressions for advertisements, and the number of conversions for advertisements.

Some of the data stored in the advertiser data 112, publisher data 114 and the performance data 116 can be used as input parameters to an advertisement auction. For example, advertisers' bids on keywords and advertisements, targeting data for the advertisements, and the historical performance of the advertisements can be used as input parameters to an advertisement auction. In particular, the advertisement management system 110, in response to each request for advertisements, can conduct an auction to select advertisements that are provided in response to the request. The advertisements can be ranked according to a score that, in some implementations, is proportional to a value based on an advertisement bid and one or more parameters specified in the performance data 116.

In some implementations, the performance data 116 can include impression data describing impressions of advertisements on publisher resources. As used herein, an impression is the providing of an advertisement for presentation on a publisher resource (such as a webpage). For each impression of an advertisement on a publisher resource, the impression data can include a publisher identifier that identifies a publisher on which the advertisement was impressed and publisher category identifiers identifying categories to which the publisher belongs. As some publishers may provide varied content (e.g., a particular publisher may provide both sports related resources and news related resources), the publisher identifier can also identify the particular webpage of the publisher on which the advertisement was shown, and the publisher category identifiers identify categories that particular webpage belongs to.

For each impression, the impression data can also include an advertiser identifier that identifies an advertiser of the advertisement, advertiser vertical identifiers identifying industry verticals to which the advertiser belongs, and attribute data describing the attributes of the impression. Such attributes can include pricing data describing cost-related attributes of the impression (e.g., a maximum bid that and advertiser bid for the impression, and actual cost of the impression, a bid type, the advertisement formats, and the like), interaction data describing user interaction events of the impression (e.g., whether the advertisement was clicked when displayed, moused over, or other interactions), and targeting information for the advertisement, a type of the advertisement. Other attribute data that describe one of more attributes of the advertiser, publisher, and the advertisement that was impressed on the publisher webpage can also be stored in the impression data.

Thus, for each impression of an advertisement on each publisher resource, the impression data can store a record that details information about the impression, the advertiser, and publisher. The advertisement management system 110 can include reporting subsystem 120 that accesses the impression data to generate different types of benchmark reports that detail the relative performance for publishers and advertisers. As will be described in more detail below, the relative performance and related performance metrics can be based on the attributes of the impressions for the publisher or the advertiser and impressions of other publishers and other advertisers.

Benchmark Reports

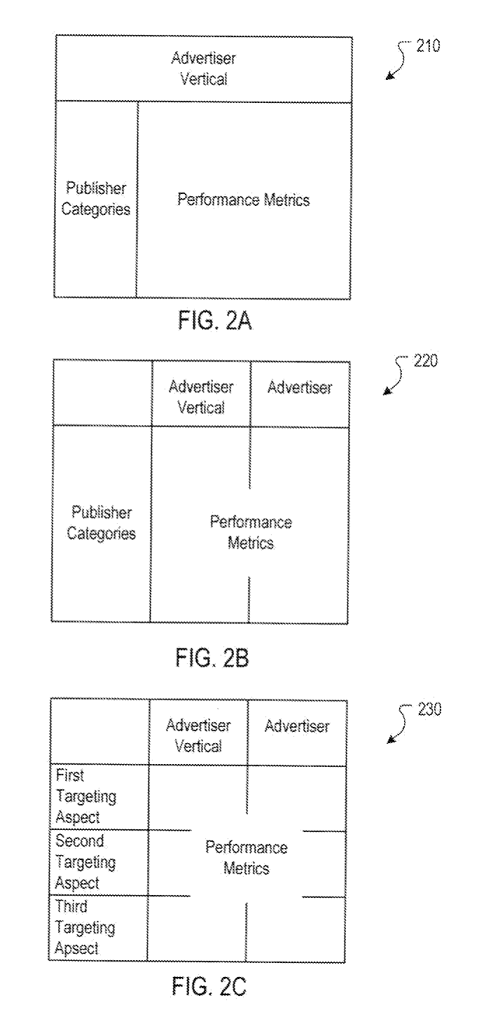

FIGS. 2A-2C are block diagrams example report types based on different benchmark specifications. A benchmark specification may define a reference by which other advertisers and/or publishers can be measured or judged. There are many types of benchmark specifications, and each may define performance metrics based on the attributes of the impressions for the publisher or the advertiser and impressions of other publishers and other advertisers.

For example, FIG. 2A illustrates an example report format 210 for a vertical performance specification for advertisers. The performance metrics may measure the performance of advertisers belonging to at least one vertical across publisher categories. These types or reports may be most useful when the advertiser objective is to measure the value of the advertisement management system 110, or when the advertiser wants to expand its advertising into the advertisement management system 110, or when the advertiser wants to advertise on the most effective publishers (according to particular performance metrics). The reports may also be informative for the entity that manages the advertisement management system, as it indicative of a macro-state of an auction. The impression data may be used to derive vertical performance metrics across publisher categories. Examples of such reports are shown in FIGS. 4-6.

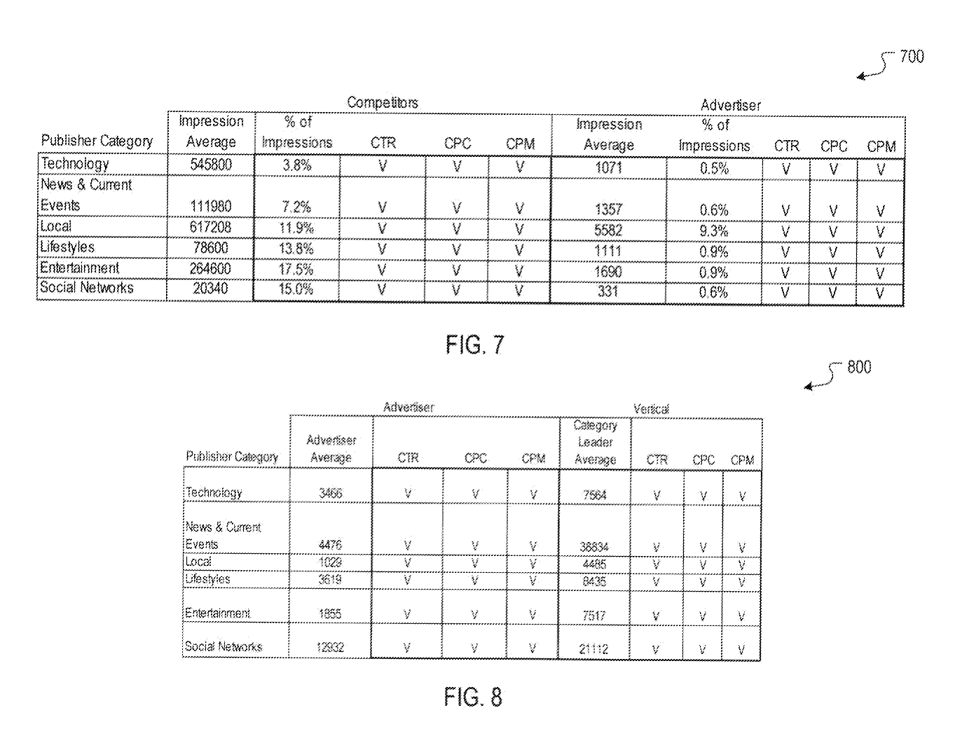

FIG. 2B illustrates an example report format 220 for an advertiser performance specification for an advertiser in a vertical. The performance metrics may measure the performance of advertisers belonging to the vertical across publisher categories. These types of reports may be most useful when the advertiser wants to determine whether an advertisement campaign performance meets the campaign goals, or the advertiser wants to compare its campaign performance against the performance of campaigns of its competitors. The impression data may be used to derive advertisement performance of the advertiser across vertical benchmarks, and are optionally filtered to the campaign goals of the advertiser. Examples of such reports are shown in FIGS. 7 and 8.

FIG. 2C illustrates an example report format 230 for a performance aspect specification for advertisers. The performance metrics may measure the performance of a performance aspect of targeted advertisements of advertisers belonging to a first vertical across publisher categories. These types or reports may be most useful when the advertiser objective is to identify the effective targeting types for its advertisements and/or campaign, wants to identify effective advertisement format types, or wants to target users most effectively. The impression data may be used to derive advertisement performance across targeting type benchmarks, advertisement format type benchmarks, and vertical performance across publisher categories. The data can be optionally filtered by campaign types.

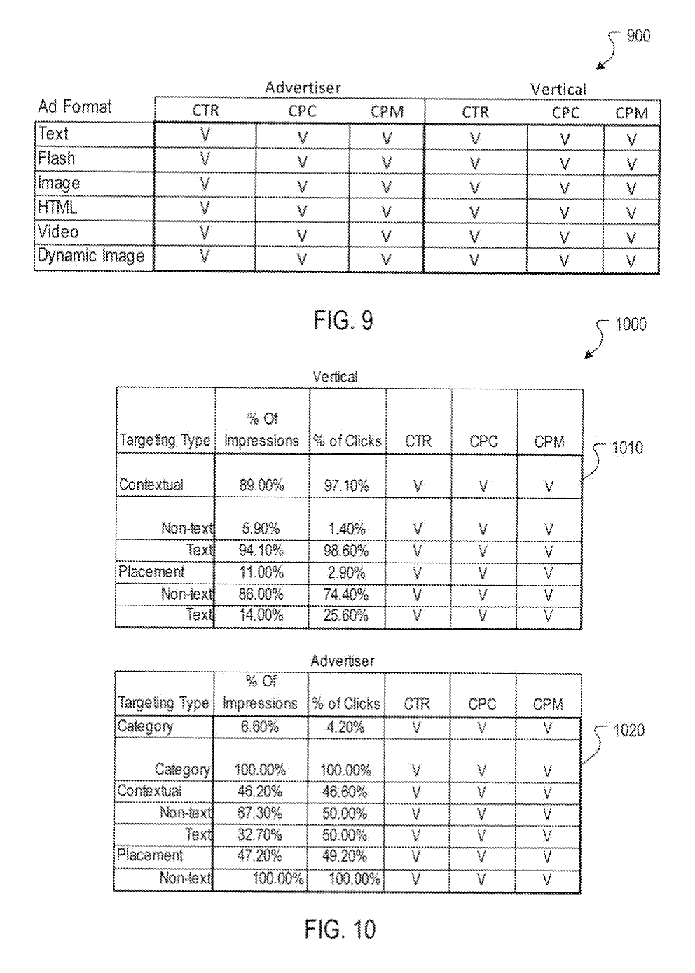

The performance aspect can include geographic regions, targeting types (e.g., contextual, placement, publisher categories (or advertiser verticals), and advertisement formats, to name just a few. Examples of such reports are shown in FIGS. 9-13.

Each of the report types above can also be pivoted so that publishers can receive similar data with respect to targeting, verticals and categories, and category performance. Thus, while the following description provides examples for advertiser reports, similar reports can also be provided for publishers.

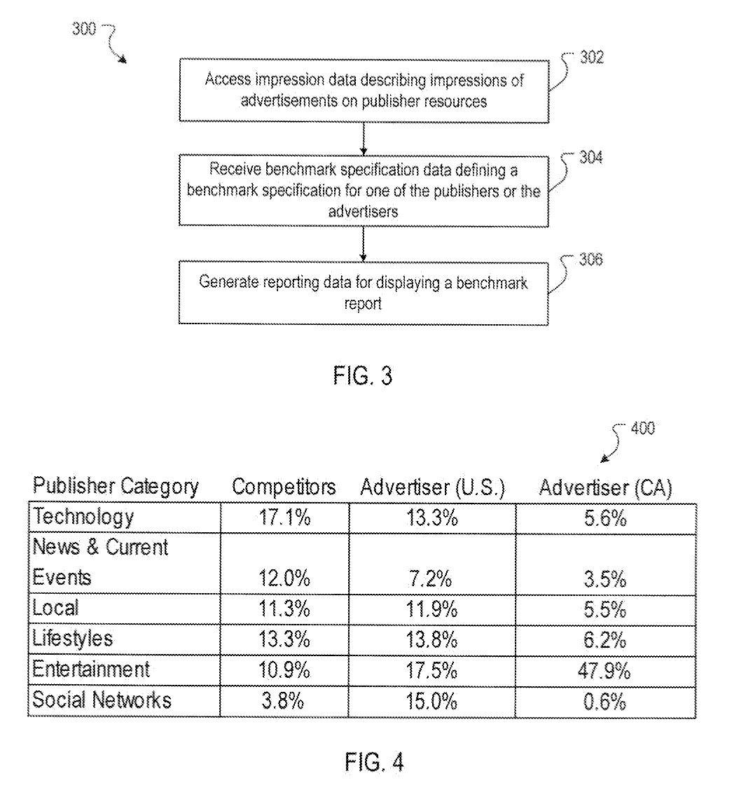

FIG. 3 is a flow diagram of an example process 300 for generating report data for a benchmark report. The process 300 can be performed in the reporting subsystem 120 of FIG. 1.

The process 300 may access impression data describing impressions of advertisements on publisher resources (302). As described above, the impression data may include, for each impression, a publisher identifier that identifies a publisher on which the advertisement was impressed and publisher category identifiers identifying categories to which the publisher belongs, an advertiser identifier that identifies an advertiser of the advertisement and advertiser vertical identifiers identifying industry verticals to which the advertiser belong, attribute data describing the attributes of the impression.

The process 300 may receive benchmark specification data defining a benchmark specification for one of the publishers or the advertisers (304). For example, data for vertical performance specification, an advertiser performance specification, or targeting specifications can be received.

The process 300 may generate reporting data for displaying a benchmark report (306). Examples of such reports, and the underlying data, are described with reference to FIGS. 4-13 below.

Example Vertical Performance Reports

FIG. 4 is an illustration of an example competitor category report 400. The report 400 can allow advertisers to evaluate their performance against other advertisers within the same vertical based on impression count. The report can be across publisher categories for performance metrics of advertisements of the advertiser belonging to the vertical and aggregate performance metrics of advertisements of advertisers belonging to the vertical. Each record can include a field for a publisher category, competitors, the number of impressions the advertiser receives in a first geographic region (e.g., the United States), and a number of impressions the advertiser receives in a second region that is a sub-region of the first region (e.g., the state of California).

The publisher category can correspond to the category of webpages (or, alternatively, publishers) on which respective impressions were attributed. For example, for resources that belong to the technology category, the portion of the percentage of the overall number of impressions that the advertiser's competitors received is 17.1%. Conversely, the advertiser received 13.3% of its total impressions on resources categorized as belonging to the technology category, and 5.6% of those impressions were received from client devices in the state of California.

The data to create the report 400 can be generated by processing the impression data according to the benchmark specification. Here, for example, the benchmark specification can define aggregate performance metrics in terms of impressions for the advertiser's competitors, and aggregate performance metrics in terms of impressions of the advertiser in the United States, and the state of California. The sample data can indicate that the advertiser receives more impressions on entertainment related webpages than its competitors, and that the advertiser relies much more heavily on social networks as a traffic driver. Depending on the advertiser's current budget, short-term and long-term objectives, etc., the advertiser may decide to significantly alter its campaign strategy, to tune certain portions of its campaign strategy, or to leave the current campaign strategy largely intact.

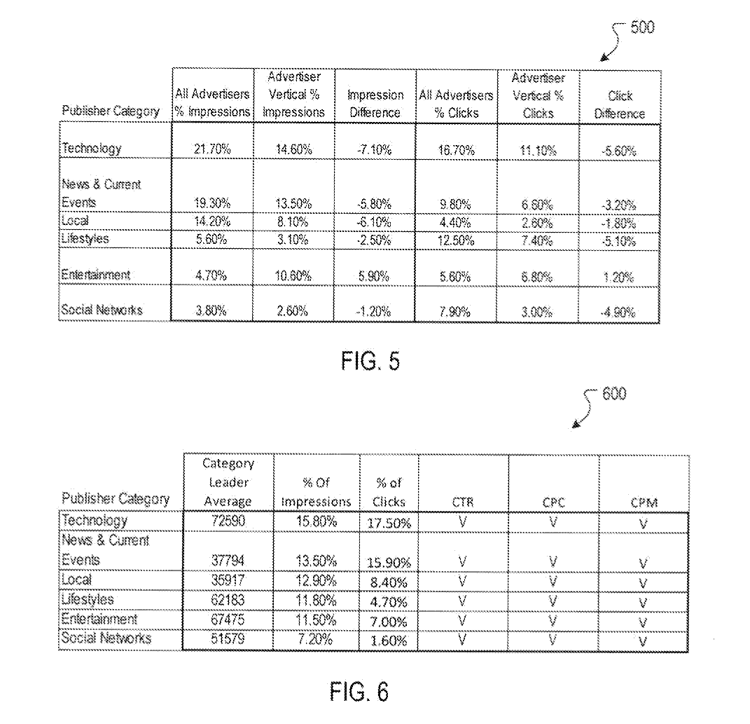

FIG. 5 is an illustration of an example performance differential report 500. The report 500 can allow an advertiser in particular vertical to determine which publisher categories are targeted by its peers. The report can be across publisher categories for aggregate performance metrics of advertisements of advertisers belonging to a set of verticals that include the vertical to which the advertiser belongs, and other verticals to which the advertiser does not belong (e.g., all verticals). The report can also include aggregate performance metrics of advertisements of advertisers that belong to the vertical.

Each record in the report 500 can include a field for a publisher category, and one more differential comparisons that describe the targeting of publisher categories for multiple advertiser verticals relative to the particular advertiser vertical. For example, an advertiser may be an automotive manufacturer, and may desire to compare the relative targeting of the publisher categories by advertisers in the automotive manufacturing vertical.

The differential report 500 can have two example differential comparisons—an impression differential comparison and a click differential comparison. Each comparison can include a first column storing data for aggregate performance metrics of advertisements of advertisers belonging to the set of verticals, a second column storing data for aggregate performance metrics of advertisements of advertisers belonging to a particular vertical, and a third column storing data for respective differences between the metrics of the first set of column and the second set of column.

For each publisher category, the impression differential comparison can include a field for the percentage of all advertisement impressions occurring on resources associated with the category, and the percentage of advertisement impressions that belong to advertisers of a vertical that occur on resources associated with the category. The final column can show the differential between the two values stored in the fields. A similar comparison can be provided for advertisement click-throughs (an interaction in which a user selects an advertisement).

The sample data can indicate that automotive advertisers purchase a larger share of impressions on entertainment related sites relative to other advertisers overall. However, the overall click through rate of advertisements for automotive advertisers is nearly on par with the overall click through rate of advertisers overall for entertainment related sites. Accordingly, an advertiser can use this data to make advertising decisions.

FIG. 6 is an illustration of an example of vertical performance report 600. The report 600 can allow advertisers in a particular vertical to determine the performance of advertisers within its vertical across different publisher categories. The report can thus be across publisher categories for aggregate performance metrics of advertisements of advertisers that belong to a vertical. Each record in the report 600 can include a field for a publisher category, and a set of column fields that can include and averaged leader metric for a particular performance metric, and other metrics, such as performance related metrics and cost related metrics.

The category leader average can display the average number of a particular metric over particular time for one or more category leaders. For example, the category leader average may be impressions over a weekly period. A category leader can be an advertiser in the particular vertical that meets the leader threshold, e.g., one of the top N advertisers in the particular vertical in terms of attributed impressions for the category.

The performance related metrics can include the click through rate (CTR), the percentage of all impressions for the particular vertical in a publisher category attributed to the category leader, and the percentage of all clicks for the particular vertical and publisher category attributed to the category leader.

The cost related metrics can include the average cost per click (CPC), and the average cost per thousand impressions (CPM). The values V for each cell in the cost related metrics can be determined from the underlying impression data aggregated over the vertical.

The vertical performance report 600 can be used to identify the most popular publisher categories were given vertical, identify high CTR or low CPC and CPM publisher categories, and can determine other characteristics of publisher categories relative to the particular vertical.

Example Advertiser Performance Reports

FIG. 7 is an illustration of an example impression category report 700. The report 700 can allow an advertiser belonging to a particular vertical to determine whether it is targeting the publisher categories that its competitors in the particular vertical are targeting, and how similar or different its targeting strategy is to (or from) its competitors' targeting strategy. The report can thus be across publisher categories for performance metrics of advertisements of an advertiser belonging to a vertical and aggregate performance metrics of advertisements of advertisers belonging to the vertical.

Each record in the report 700 can include a field for a publisher category, one or performance metrics and other performance related data aggregated for advertisements of advertisers belonging to the vertical, and one, or more performance metrics and other performance related data aggregated for the advertiser.

The sample data can indicate that the advertiser may be underrepresented in certain publisher categories relative to its peers. Depending on the cost related metrics, the advertiser may decide to allocate additional budget to targeting in certain publisher categories. The sample data may also indicate where the advertiser is performing well relative to its peers in certain technology areas. For example, the sample data may indicate that the publisher category of “Local”, the advertiser is paying much less on an average cost per click and has a much higher click through rate than its competitors in the same category have. Accordingly, the advertiser may decide that no refinements to the campaign are necessary with respect to that particular publisher category.

FIG. 8 is an illustration of an example advertiser benchmark report 800. The report 800 can allow an advertiser to compare the performance of its advertisements to the performance of the advertisements of its peers within the same vertical and across publisher categories. Each record in the report can include a field for a publisher category, and can include a first set of fields that are specific to the advertiser, and a second set of fields that are specific to the vertical to which the advertiser belongs. The advertiser average and the category leader average fields respectively can display the average number of a particular metric over particular time for the advertiser and one or more category leaders. The advertiser may be included is a category leader, if the advertiser's performance metrics meet a category leader threshold for the particular publisher category. For example, the metrics may be an average number of impressions over a given period of time in each publisher category.

For both the advertiser and the vertical fields, corresponding performance metrics can also displayed. In the example report 800, the corresponding performance metrics can be the click through rate, the cost per click, and the cost per thousand impressions. The report 800 can allow an advertiser to quickly assess how its advertisements are performing relative to the advertisements of its peers in various publisher categories. Depending on performance metrics shown, the advertiser may decide whether to adjust an advertising campaign, or leave an advertising campaign intact. For example, the advertiser may identify opportunities in publisher categories in which the vertical performs relatively well and in which it is underrepresented. Likewise, the advertiser can determine best-performing publisher categories among its peers.

Example Performance Aspects Reports

FIG. 9 is an illustration of an example competitor format report 900. The report 900 can allow advertisers to determine the relative performance of various advertising formats in its vertical. An advertising format can be a display format of a particular advertisement, e.g., text, video, image, etc. The report can thus be across advertisement formats for aggregate performance metrics of advertisements of an advertiser belonging to the vertical and aggregate performance metrics of advertisements of other advertisers belonging to the vertical.

The report 900 can include a first column that describes advertisement formats, a first set of columns describing aggregate performance metrics of advertisements of advertisers belonging to the vertical, and a second set of columns describing aggregate performance metrics of advertisements of only the first advertiser. For example, the sample data can include the click through rate, the average cost per click, and the cost per thousand impressions for each advertisement of a particular format.

Based on the values, an advertiser can determine which advertisement format(s) performs the best for its vertical. Furthermore, if the advertiser is not using advertisements of the particular format, and advertisements of that particular format perform well in its vertical, then the advertiser may consider whether to include advertisements of the particular format in its campaign. For example, assume that video advertisements perform best in the particular vertical of the advertiser, but the advertiser is only using text and flash-based advertisements. A possible advertising strategy for the advertiser would be to expand its advertisements into the video format.

FIG. 10 is an illustration of an example competitor targeting type report 1000. The report 1000 allows advertisers to determine the relative performance of various targeting types in its vertical. A targeting type can be a targeting strategy. For example, the contextual targeting strategy can target advertisements based on keywords and/or publisher categories. The placement targeting strategy can be a targeting strategy that involves identifying particular webpages and/or websites on which advertisements are to be impressed. A category targeting strategy can be a targeting strategy that is based on publisher categories.

Additionally, a targeting type can have subtypes, each of which is variations of the targeting type. As shown in court 1000, there can be two subtypes—non-text and text. Non-text can refer to the targeting of non-text advertisements (e.g., videos, images, flash animations) and text can refer to the targeting of text advertisements.

The report can be across targeting types for aggregate performance metrics of advertisements of an advertiser belonging to a vertical and aggregate performance metrics of advertisements of other advertisers belonging to the vertical. The report 1000 can include a first set of columns 1010 storing data for aggregate performance metrics of advertisements of advertisers belonging to the first vertical, and a second set of columns 1020 storing data for aggregate performance metrics of advertisements of only the advertiser.

The sample data can indicate that contextual advertisements capture the vast majority of all category impressions (89%) and clicks (97%) within the vertical. Furthermore, assume that the click through rate of the contextual advertisements for the advertiser is approximately one-quarter of the click through rate of the contextual advertisements of advertisers within the vertical. This would indicate that the contextual advertisements of other advertisers in the vertical outperform the contextual advertisements of the advertiser. Accordingly, the advertiser would likely decide to adjust its keyword targeting strategy to improve its performance relative to that of its competitors.

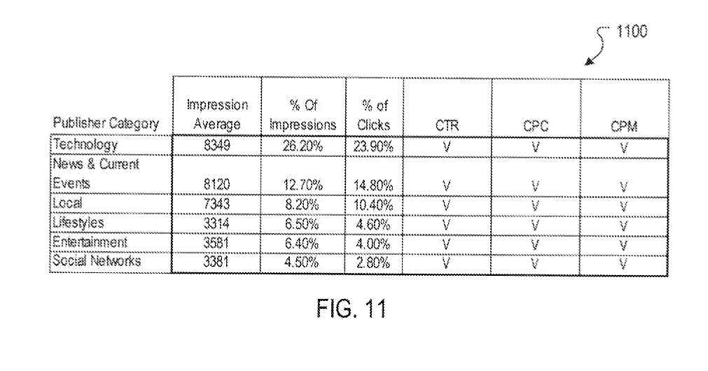

FIG. 11 is an illustration of an example publisher category report 1100. The report 1100 can allow advertisers to identify which publisher categories attract its target audience. The reporting can be across publisher categories for aggregate performance metrics of advertisements of an advertiser belonging to the first vertical. In some implementations, the aggregate performance metrics can be for all advertisers within the vertical of the advertiser.

For each publisher category, the report can include the average number of impressions over a given time, the percentage of all impressions for the vertical that the webpages belonging to the category received, the percentage of all clicks for the vertical that the advertisements shown on the webpage belonging to the category received, and other corresponding metrics, such as cost metrics.

The categories can be sorted in descending order of impression percentages. Other sorts are also possible. The report can allow advertisers to better determine how optimize assets and target advertisements to categories where targeted users are found.

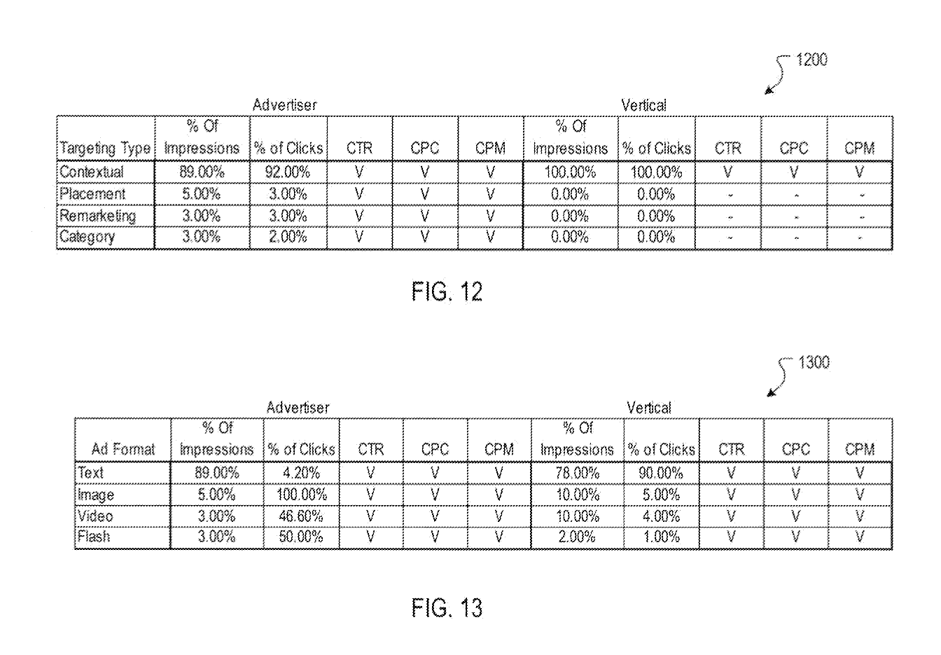

FIG. 12 is an illustration of an example targeting type benchmark report 1200. The report 1200 can allow an advertiser to determine the relative performance of various targeting types in its campaign to the performance of the various targeting types in its vertical. The report can be across targeting types of performance metrics for advertisements of the advertiser and the performance metrics of advertisements of other advertisers belonging to the vertical.

FIG. 13 is an illustration of an advertisement format benchmark report 1300. The report 1300 can allow an advertiser to determine the relative performance of various advertisement formats in its campaign to the performance of various advertisement formats in its vertical. The report can be across advertisement formats for performance metrics of advertisements of the advertiser and performance metrics of advertisements of other advertisers belonging to the vertical.

The reports 1200 and 1300 can compare advertisers' performance to its vertical across multiple targeting types and advertisement formats. An advertiser can use these reports to identify the best performing targeting types in its vertical, assesses targeting strategy, identify the best performing advertising formats in its vertical, and identify new advertisement formats to use.

Additional Implementation Details

The example reports described above are illustrative only, and other reports for performance metrics based on the attributes of the impressions for the publisher or the advertiser and impressions of other publishers and other advertisers across both publisher categories and advertiser verticals can also be used.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous

What is claimed is:

1. A system, comprising:
a data processing apparatus; and
a data storage apparatus encoded with instructions that when executed by the data processing apparatus cause the data processing apparatus to perform operations comprising:
accessing impression data describing impressions of advertisements on publisher resources, wherein for each impression of an advertisement on a publisher resource, the impression data comprises:
a publisher identifier that identifies a publisher on which the advertisement was impressed and publisher category identifiers identifying categories to which the publisher belongs;
an advertiser identifier that identifies an advertiser of the advertisement and advertiser vertical identifiers identifying industry verticals to which the advertiser belongs; and
attribute data describing the attributes of the impression, the attribute data comprising pricing data describing cost-related attributes of the impression, and interaction data describing user interaction events of the impression;
receiving benchmark specification data defining a benchmark specification for one of the publishers or the advertisers, and further defining performance metrics based on the attributes of the impressions for the publisher or the advertiser and impressions of other publishers and other advertisers;
determining performance metric values from the impression data and the benchmark specification data, the determining comprising determining first performance metric values for a set of performance metrics and second performance metric values for the set of performance metrics, the first performance metric values being for only one of the publishers or advertisers, and the second performance metric values being for a respective plurality of other publishers or advertisers, and wherein the first performance metric values are separate from and respectively relative to the other second performance metric values of the other publishers or advertisers; and
generating reporting data for displaying a benchmark report that displays the first performance metric values and the second performance metric values, the reporting data defining a report of the first performance metric values for the one of the publishers or advertisers respectively relative to the second performance metric values of the other publishers or other advertisers and grouped by at least one respective publisher category or advertiser category.

2. The system of claim 1, wherein the benchmark specification data define a vertical performance specification for advertisers and the performance metrics measure the performance of advertisers belonging to at least one vertical across publisher categories.

3. The system of claim 2, wherein:
determining performance metric values comprises determining metric values for publisher categories of performance metrics of advertisements of a first advertiser belonging to a first vertical and aggregate performance metrics of advertisements of advertisers belonging to the first vertical; and
the reporting data define a report across the publisher categories of performance metrics of advertisements of the first advertiser belonging to the first vertical and the aggregate performance metrics of advertisements of the advertisers belonging to the first vertical.

4. The system of claim 2, wherein:
determining performance metric values comprises determining metric values for publisher categories of aggregate performance metrics of advertisements of advertisers belonging to a set of verticals that comprise a first vertical to which an advertiser belongs and other verticals to which the advertiser does not belong, and aggregate performance metrics of advertisements of advertisers that belong to the first vertical; and
the reporting data define a report across the publisher categories of aggregate performance metrics of advertisements of the advertisers belonging to the set of verticals that comprise the first vertical to which the advertiser belongs and the other verticals to which the advertiser does not belong, and the aggregate performance metrics of advertisements of the advertisers that belong to the first vertical.

5. The system of claim 4, wherein the report comprises data defining:
a first column of storing data for publisher categories;
a first set of columns storing data for aggregate performance metrics of advertisements of advertisers belonging to the set of verticals;
a second set of columns storing data for aggregate performance metrics of advertisements of advertisers belonging to the first vertical; and
a third set of columns storing data for respective differences between the metrics of the first set of columns and the second set of columns.

6. The system of claim 2, wherein:
determining performance metric values comprises determining metric values across publisher categories of aggregate performance metrics of advertisements of advertisers that belong to a first vertical; and
the reporting data define a report across the publisher categories of aggregate performance metrics of the advertisements of the advertisers that belong to the first vertical.

7. The system of claim 6, wherein the report comprises data defining:
a first column of storing data for publisher categories; and
a first set of columns storing data for aggregate performance metrics of advertisements of advertisers belonging to the first vertical.

8. The system of claim 1, wherein the benchmark specification data define a performance aspect specification for advertisers and the performance metrics measure the performance of advertisements of advertisers belonging to a first vertical across publisher categories relative to the performance aspect.

9. The system of claim 8, wherein:
the performance aspects comprise advertisement formats;
determining performance metric values comprises determining metric values across advertisement formats of aggregate performance metrics of advertisements of an advertiser belonging to the first vertical and aggregate performance metrics of advertisements of other advertisers belonging to the first vertical; and
the reporting data define a report across the advertisement formats of the aggregate performance metrics of the advertisements of the advertiser belonging to the first vertical and aggregate performance metrics of advertisements of the other advertisers belonging to the first vertical.

10. The system of claim 9, wherein the report comprises data defining:
a first column of storing data for advertisement formats;
a first set of columns storing data for aggregate performance metrics of advertisements of advertisers belonging to the first vertical; and
a second set of columns storing data for aggregate performance metrics of advertisements of only the first advertiser.

11. The system of claim 9, wherein:
the performance aspects comprise targeting types;
determining performance metric values comprises determining metric values across targeting types of aggregate performance metrics of advertisements of an advertiser belonging to the first vertical and aggregate performance metrics of advertisements of other advertisers belonging to the first vertical; and
the reporting data define a report across the targeting types of the aggregate performance metrics of the advertisements of the advertiser belonging to the first vertical and the aggregate performance metrics of the advertisements of the other advertisers belonging to the first vertical.

12. The system of claim 11, wherein the report comprises data defining:
a first column of storing data for targeting types;
a first set of columns storing data for aggregate performance metrics of advertisements of advertisers belonging to the first vertical; and
a second set of columns storing data for aggregate performance metrics of advertisements of only the first advertiser.

13. The system of claim 8, wherein:
determining performance metric values comprises determining metric values across publisher categories of aggregate performance metrics of advertisements of an advertiser belonging to the first vertical; and
the performance aspects comprise the publisher categories, and the reporting data define a report across the publisher categories of the aggregate performance metrics of the advertisements of the advertiser belonging to the first vertical.

14. The system of claim 8, wherein:
the performance aspects comprise targeting types;
determining performance metric values comprises determining metric values across targeting types of performance metrics of advertisements of an advertiser belonging to a first vertical and performance metrics of advertisements of other advertisers belonging to the first vertical;
the reporting data define a report across the targeting types of the performance metrics of the advertisements of the advertiser belonging to the first vertical and the performance metrics of the advertisements of the other advertisers belonging to the first vertical.

15. The system of claim 8, wherein:
the performance aspects comprise advertisement formats;
determining performance metric values comprises determining metric values across advertisement formats of performance metrics of advertisements of an advertiser belonging to a first vertical and performance metrics of advertisements of other advertisers belonging to the first vertical; and
the reporting data define a report across the advertisement formats of the performance metrics of the advertisements of the advertiser belonging to the first vertical and performance metrics of the advertisements of the other advertisers belonging to the first vertical.

16. A method implemented in a data processing apparatus, comprising:
accessing, by a data processing apparatus, impression data describing impressions of advertisements on publisher resources, wherein for each impression of an advertisement on a publisher resource, the impression data comprises:
a publisher identifier that identifies a publisher on which the advertisement was impressed and publisher category identifiers identifying categories to which the publisher belongs;
an advertiser identifier that identifies an advertiser of the advertisement and advertiser vertical identifiers identifying industry verticals to which the advertiser belongs; and
attribute data describing the attributes of the impression, the attribute data comprising pricing data describing cost-related attributes of the impression, and interaction data describing user interaction events of the impression;
receiving, by the data processing apparatus, benchmark specification data defining a benchmark specification for one of the publishers or the advertisers, and further defining performance metrics based on the attributes of the impressions for the publisher or the advertiser and impressions of other publishers and other advertisers;
determining, by the data processing apparatus, performance metric values from the impression data and the benchmark specification data, the determining comprising determining first performance metric values for a set of performance metrics and second performance metric values for the set of performance metrics, the first performance metric values being for only one of the publishers or advertisers, and the second performance metric values being for a respective plurality of other publishers or advertisers, and wherein the first performance metric values are separate from and respectively relative to the other second performance metric values of the other publishers or advertisers; and
generating, by the data processing apparatus, reporting data for displaying a benchmark report that displays the first performance metric values and the second performance metric values, the reporting data defining a report of the first performance metric values for the one of the publishers or advertisers respectively relative to the second performance metric values of the other publishers or other advertisers and grouped by at least one respective publisher category or advertiser category.

17. The method of claim 16, wherein the benchmark specification data define an advertiser performance specification for a first advertiser in a first vertical, and the performance metrics measure the performance of advertisers belonging to the vertical across publisher categories.

18. The method of claim 17, wherein:
determining performance metric values comprises determining metric values across publisher categories of performance metrics of advertisements of the first advertiser belonging to the first vertical and aggregate performance metrics of advertisements of advertisers belonging to the first vertical; and
the reporting data define a report across the publisher categories of the performance metrics of the advertisements of the first advertiser belonging to the first vertical and the aggregate performance metrics of the advertisements of the advertisers belonging to the first vertical.

19. The method of claim 18, wherein the report comprises data defining:
a first column of storing data for publisher categories;
a first set of columns storing data for aggregate performance metrics of advertisements of advertisers belonging to the first vertical; and
a second set of columns storing data for aggregate performance metrics of advertisements of only the first advertiser.

20. Software stored in a computer memory device accessible by a data processing apparatus that upon such execution cause the data processing apparatus to perform operations comprising:
accessing impression data describing impressions of advertisements on publisher resources, wherein for each impression of an advertisement on a publisher resource, the impression data comprises:
a publisher identifier that identifies a publisher on which the advertisement was impressed and publisher category identifiers identifying categories to which the publisher belongs;
an advertiser identifier that identifies an advertiser of the advertisement and advertiser vertical identifiers identifying industry verticals to which the advertiser belongs; and
attribute data describing the attributes of the impression, the attribute data comprising pricing data describing cost-related attributes of the impression, and interaction data describing user interaction events of the impression;
receiving benchmark specification data defining a benchmark specification for one of the publishers or the advertisers, and further defining performance metrics based on the attributes of the impressions for the publisher or the advertiser and impressions of other publishers and other advertisers;
determining performance metric values from the impression data and the benchmark specification data, the determining comprising determining first performance metric values for a set of performance metrics and second performance metric values for the set of performance metrics, the first performance metric values being for only one of the publishers or advertisers, and the second performance metric values being for a respective plurality of other publishers or advertisers, and wherein the first performance metric values are separate from and respectively relative to the other second performance metric values of the other publishers or advertisers; and
generating reporting data for displaying a benchmark report that displays the first performance metric values and the second performance metric values, the reporting data defining a report of the first performance metric values for the one of the publishers or advertisers respectively relative to the second performance metric values of the other publishers or other advertisers and grouped by at least one respective publisher category or advertiser category.
